(19) United States
(12) Patent Application Publication
(10) Pub. No.: US 2014/0297298 A1
(43) Pub. Date: Oct. 2, 2014

(54) SYSTEMS AND METHODS FOR ADJUSTING BENEFIT LEVELS FOR HEALTHCARE TRANSACTIONS PREVIOUSLY REJECTED FOR PRIOR AUTHORIZATION BY A PRIMARY PAYOR

(71) Applicant: MCKESSON SPECIALTY ARIZONA INC., Scottsdale, AZ (US)

(72) Inventor: Derek Rago, Scottsdale, AZ (US)

(73) Assignee: MCKESSON SPECIALTY ARIZONA INC., Scottsdale, AZ (US)

(21) Appl. No.: 13/853,385

(22) Filed: Mar. 29, 2013

(51) Int. Cl. G06Q 50/22; G06Q 10/00

(52) U.S. Cl. CPC G06Q 50/22; G06Q 10/00
USPC 705/2

(57) ABSTRACT

Systems and methods are provided for adjusting secondary benefit levels for healthcare transactions for which primary benefits were previously rejected for lack of prior authorization by a primary payor. A healthcare transaction may be received from a primary payor computer. The transaction may include patient information, loyalty card information, a request for healthcare benefits, and a refill request for a prescribed medication or service. The administrator computer can determine the transaction is approved by the primary payor computer. The transaction can include a designation of a primary benefit from the primary payor. The administrator computer can determine that a prior authorization requirement for the primary payor has been satisfied based in part on the determination that the transaction is approved by the primary payor. The administrator computer can also change the healthcare benefits provided for the client from a second secondary benefits program to a first secondary benefits program.

### TECHNICAL FIELD

Aspects of the disclosure relate generally to benefits provided by a secondary payor related to healthcare transactions, and more particularly, to systems and methods for adjusting benefit levels for healthcare transactions previously rejected for prior authorization by a primary payor.

### BACKGROUND

A healthcare provider, such as a pharmacy, pharmacist, doctor's office, urgent care center, physician, hospital, or the like provides numerous healthcare related services to patients. One of these services is to, at times, provide prescription medications to a patient. Typically, a healthcare transaction, such as a predetermination of benefits transaction, healthcare claim transaction, prescription claim or billing request, healthcare order transaction, or e-prescription transaction (i.e., electronic prescription order transaction, e-script, or e-prescription), is generated by the healthcare provider and sent, either directly or indirectly, to a primary payor for adjudication. In certain cases, the healthcare transaction is sent to a primary payor for adjudication or a primary benefit and then sent to a secondary payor for adjudication of a secondary claim benefit related to the healthcare transaction. In some cases, the healthcare transaction is sent to a primary payor or secondary payor (e.g., an administrator) by way of a service provider or switch. The healthcare transaction typically includes information that identifies the patient, the medication being requested, the healthcare provider (either the prescriber, pharmacy, or both), the primary payor, the secondary payor (if any) and the benefit plan for the patient.

In certain situations, the healthcare provider has to make a determination as to whether the client (e.g., the patient or party requesting the medication) has received prior authorization before dispensing the medication. A prior authorization rejection or request is one where the primary payor (e.g., pharmacy benefits manager, insurance company, or other benefits payor) initially will not pay out primary benefits to a client for a prescribed medication and requires that the prescriber (e.g., doctor, dentist, etc.) contact the primary payor to provide additional information to the primary payor. For example, the primary payor may want to make sure that a generic or other equivalent medication cannot be substituted for the prescribed medication, or that other alternative medications or therapies have been attempted or a reason given why they should not need to be attempted in this case.

Typically, when a healthcare provider receives a rejection of a healthcare claim transaction based on a need for prior authorization, the healthcare provider, such as pharmacy, must contact the prescriber directly to get the prescriber to provide the necessary information to the primary payor for payment. Alternatively, the healthcare provider may have to send a request for prior authorization assistance to a service provider (who then contacts the prescriber) and advise the patient that a prior authorization request has been initiated as part of a healthcare transaction. In either event, the client is usually not able to receive the benefits provided by the primary payor during that visit to the pharmacy. The client will typically either have to: a) pay an additional amount for the prescribed medication/service that is typically equal to that which would normally be covered by the benefits provided by the primary payor; or b) be required to return at a later time that day or at a later date, after the prior authorization requirements have been met. Unfortunately, in many cases the client is not willing to pay the additional amount and does not return to try and obtain the current prescription later on, which leads to an effective abandonment of the current prescription. By not fulfilling the prescription, the client/patient may be at risk because they are not taking their prescribed medication. Further, the healthcare provider and the pharmaceutical manufacture miss out on revenue related to a potential sale of the prescribed medication.

### SUMMARY

Exemplary embodiments disclosed herein may include systems and methods for adjusting secondary benefit levels for healthcare transactions previously rejected for prior authorization by a primary payor and completed as part of the processing of a healthcare transaction in real-time or near real-time. In one exemplary embodiment, a computer-implemented method for adjusting the secondary benefit levels for healthcare transactions may be provided and performed by one or more computers associated with an administrator. A healthcare transaction for a patient may be received from a primary payor computer associated with a primary payor. The healthcare transaction may include patient information, loyalty card information, a request for provision of healthcare benefits, and a request for a refill of a prescribed medication or service. The administrator computer can determine that the healthcare transaction is approved by the primary payor computer. The healthcare transaction can include a designation of a primary benefit from the primary payor. The administrator computer can determine that a prior authorization requirement for the primary payor has been satisfied based at least in part on the determination that the healthcare transaction is approved by the primary payor computer. The administrator computer can also change the healthcare benefits being provided for the client from a second secondary benefits program to a first secondary benefits program.

In accordance with another example embodiment, a system for adjusting secondary benefit levels for healthcare transactions previously rejected for prior authorization by a primary payor as part of the processing of a healthcare transaction may be provided. The system may include at least one memory operable to store computer-executable instructions. The system may also include at least one processor configured to access the at least one memory and execute the computer-executable instructions. The processor may be configured to receive from the primary payor computer associated with a primary payor, a healthcare transaction for a patient. The healthcare transaction may include patient information, loyalty card information, a request for a provision of healthcare benefits, and a request for a refill of a prescribed medication or service. The processor may be further configured to determine that the healthcare transaction is approved by the primary payor computer. The healthcare transaction may include a designation of a primary benefit from the primary payor. The processor may be further configured to determine that a prior authorization requirement for the primary payor has been satisfied based at least in part on the determination that the healthcare transaction is approved by the primary payor computer. The processor may be further configured to change the provision of healthcare benefits for the client from a second secondary benefits program to a first secondary benefits program.

### BRIEF DESCRIPTION OF THE DRAWINGS

Reference will now be made to the accompanying drawings, which are not necessarily drawn to scale, and wherein:

FIG. 1 illustrates an example overview of a system that facilitates adjusting secondary benefit levels for healthcare transactions for which primary benefits payments were previously rejected for lack of prior authorization by a primary payor and completed as part of the processing of a healthcare transaction, according to one exemplary embodiment.

FIG. 2 is a diagram of an example data flow for adjusting the secondary benefit level for a healthcare transaction related to a prior healthcare transaction for which primary benefits payment was rejected for lack of prior authorization by a primary payor and completed as part of the processing of a healthcare transaction, according to one exemplary embodiment.

FIGS. 3A and B are a flow chart of an example method for providing a premium secondary benefit for healthcare transactions for which primary benefits are currently rejected by a primary payor for lack of prior authorization by the primary payor and completed as part of the processing of a healthcare transaction, according to one exemplary embodiment.

FIG. 4 is a flow chart of an example method for adjusting the secondary benefit level for a healthcare transaction related to a prior healthcare transaction for which primary benefits payment was rejected for lack of prior authorization by a primary payor and completed as part of the processing of the healthcare transaction according to one exemplary embodiment.

### DETAILED DESCRIPTION OF EXEMPLARY EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Exemplary embodiments described herein include systems and methods that facilitate adjusting secondary benefit levels for healthcare transactions previously rejected for prior authorization by a primary payor and completed as part of the processing of a healthcare transaction in real-time or near real-time. For example, a refill request for a prescription medication may be received from a client (e.g., a patient or other party making the request) at a healthcare provider (e.g, pharmacist, pharmacy, hospital, physician, doctor's office, clinic, etc.) along with a loyalty card and insurance card if any. A healthcare transaction may be generated by the healthcare provider and can include information related to the patient, the prescribed medication, a primary payor, a secondary payor, and number or code associated with the loyalty card. The healthcare transaction can be transmitted directly or indirectly to the primary payor for adjudication. The primary payor can adjudicate the healthcare transaction and it may then be transmitted directly or indirectly to a party providing a secondary benefit (i.e. a secondary payor or administrator) to determine if a secondary benefit will be provided. A determination can be made that the current healthcare transaction was approved by the primary payor but the prior fill for that client/patient for that medication, based on an evaluation and/or association with the loyalty card, was rejected based on a need for prior authorization by the primary payor. The secondary payor (e.g., the administrator) may move or change the association for the client/patient (e.g., based on the number or code associated with the loyalty card to thereby modify the amount of benefit being provided to the client/patient as a secondary benefit for the prescribed medication and/or service. For example, the secondary payor may pay for all or substantially all of the purchase amount for a medication and/or service under a first program initiated when the healthcare transaction was originally rejected based on a need for prior authorization. Thereafter, once the prior authorization is received (and the primary payor begins providing a primary benefit in response to refills of the prescribed medication or service in the original healthcare transaction), the client/patient may be moved to a second program under the secondary payer that provides a secondary benefit that is at a different level (typically substantially less) than that provided under the first program.

System Overview

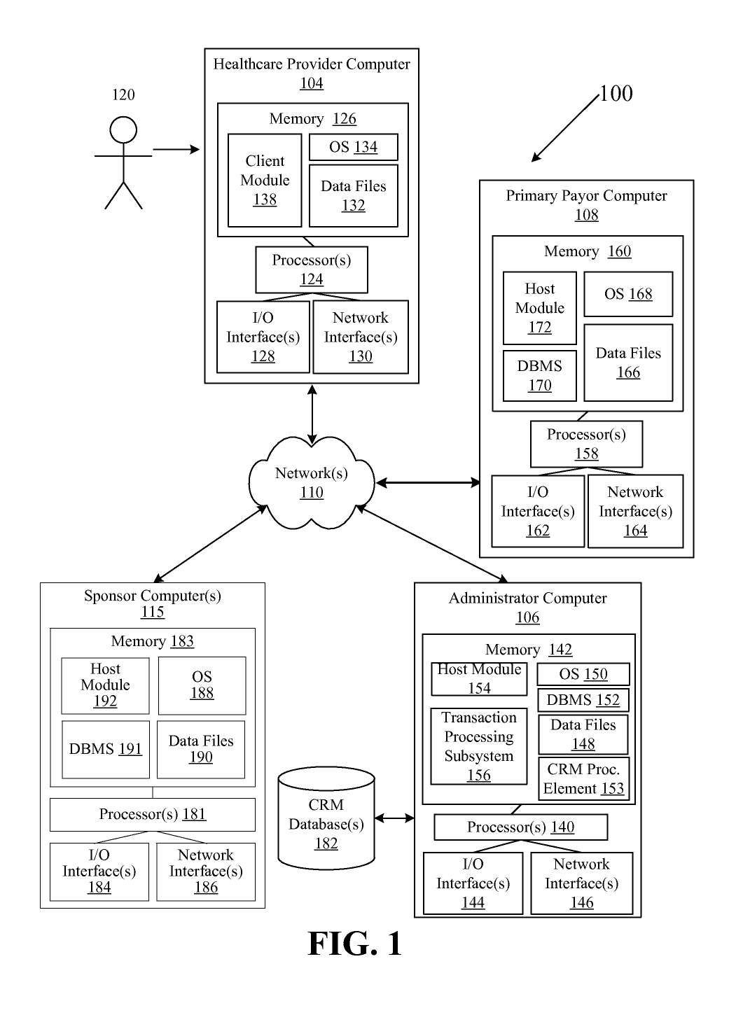

FIG. 1 illustrates an example system 100 supporting healthcare transactions, electronic prescription ordering activities, prescription billing activities, and patient coverage eligibility verifications according to one example embodiment. The exemplary system 100 facilitates adjusting secondary benefit levels for healthcare transactions for which primary benefits have been previously rejected for prior authorization by a primary payor as part of or in-line with the processing of healthcare transactions, including, but not limited to prescription claim transactions, and will now be described illustratively with respect to FIG. 1. As shown in FIG. 1, the system 100 may include at least one client 120, at least one healthcare provider computer 104, at least one administrator computer 106, at least one sponsor computer 115, and at least one primary payor computer 108.

As desired, each of the client 120, healthcare provider computer 104, administrator computer 106, sponsor computer 115, and/or primary payor computer 108 may include one or more processing devices that may be configured for accessing and reading associated computer-readable media having stored thereon data and/or computer-executable instructions for implementing the various methods disclosed in the exemplary embodiments discussed herein. Alternatively, each of the client 120, healthcare provider 104, primary payer 108, administrator 106, and sponsor 115 can include or otherwise be associated with a user carrying out the functions of the respective entity. For example, the client 120 can include a client user communicating across a PSTN (e.g., network 110) or in person with an administrator user operating one or more administrator processing elements, where the administrator user and processing elements collectively make up all or a portion of the administrator computer 106.

Additionally, in certain exemplary embodiments, the administrator computer 106 may be in communication with one or more data storage devices, such as a customer relationship management (CRM) database 182. The CRM database 182 may receive, store, and provide, as needed, demographic information such as the client's name, address, telephone number, e-mail address, and the like. The client information may include the aforementioned client identification (ID) number and/or source code associated with the respective client, which may be included on a loyalty card issued to the client. In addition, the client information may include a listing of one or more programs of the administrator to which the client is enrolled (or program identification numbers of such programs), one or more goods (e.g., prescription medications) and/or services to which the client's enrolled programs are applicable, any particular services and/or benefits associated with respective applicable goods/services, historical purchases of applicable goods and/or services, the timing and/or frequency of those historical purchases, any scheduled forthcoming purchases of applicable goods and/or services, or the like. Alternatively, the data storage function may be included in the administrator computer itself, such as in the memory 142.

Generally, network devices and systems, including one or more of the client 120, the healthcare provider computer 104, administrator computer 106, sponsor computer 115, and primary payor computer 108 may include or otherwise be associated with suitable hardware and/or software for transmitting and receiving data and/or computer-executable instructions over one or more communications links or networks. These network devices and systems may also include any number of processors for processing data and executing computer-executable instructions, as well as other internal and peripheral components that are well known in the art. Further, these network devices and systems may include or be in communication with any number of suitable memory devices operable to store data and/or computer-executable instructions. By executing computer-executable instructions, each of the network devices may form a special purpose computer or particular machine. As used herein, the term “computer-readable medium” describes any form of suitable memory or memory device.

As shown in FIG. 1, one or more of the client 120, healthcare provider computer 104, administrator computer 106, sponsor computer 115, primary payor computer 108, and CRM database 182 may be in communication with each other via one or more networks, such as network 110, which as described below can include one or more separate or shared private and public networks, including the Internet or a publicly switched telephone network. Each of these components—the client 120, healthcare provider computer 104, administrator computer 106, sponsor computer 115, primary payor computer 108, CRM database 182, and the network 110 will now be discussed in further detail.

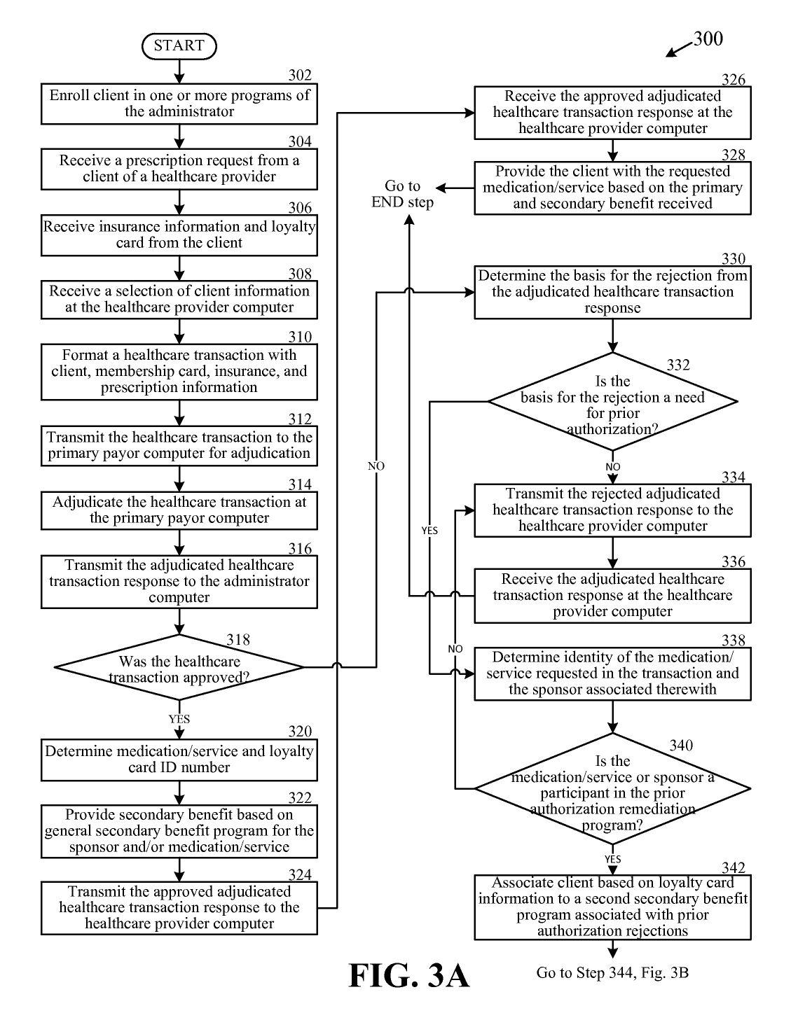

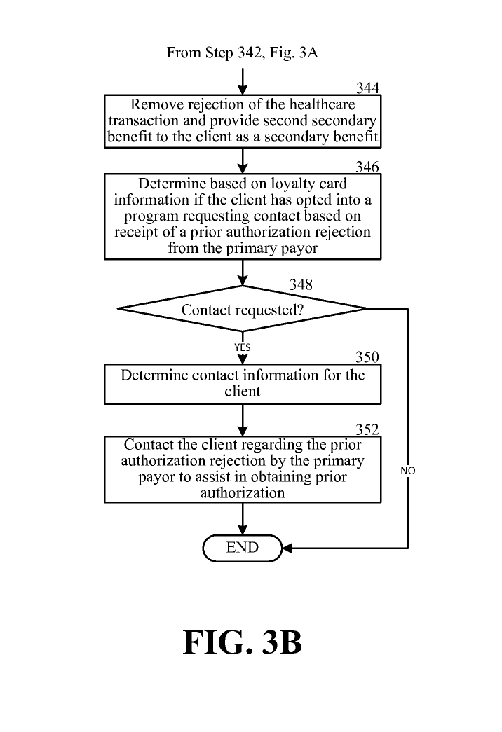

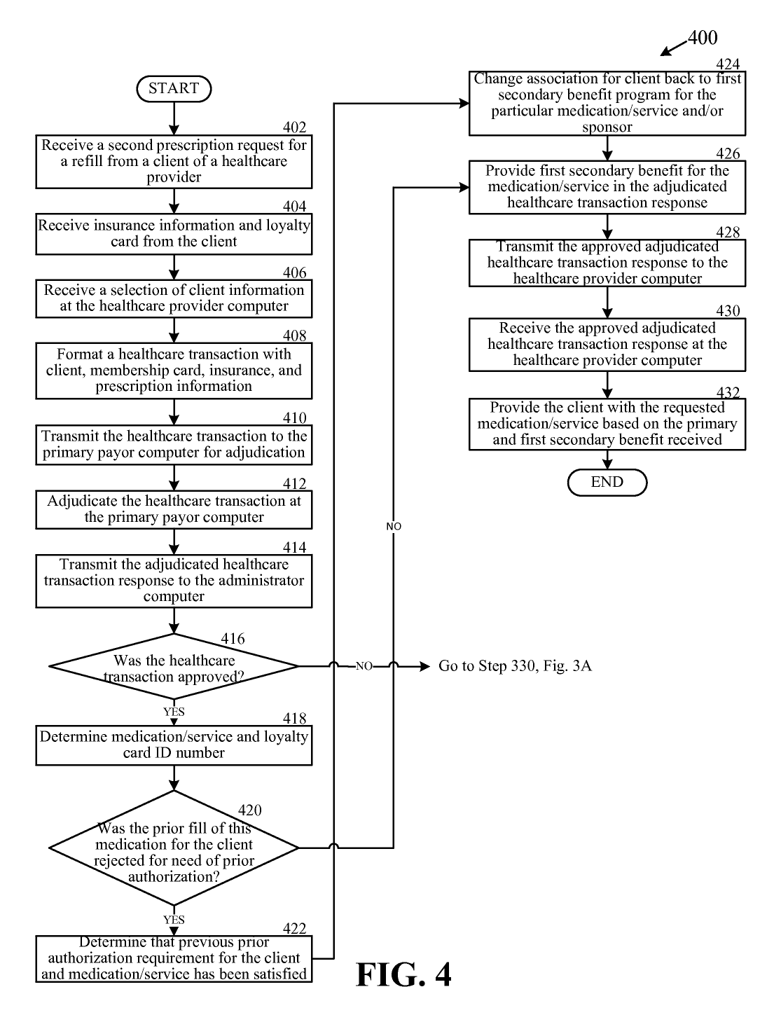

Each healthcare provider computer 104 may be associated with a healthcare provider, such as, for example, a pharmacy, physician's office, hospital, clinic, etc. While the exemplary healthcare provider computer 104 will be described as within or part of a pharmacy or pharmacy network with regard to the methods of FIGS. 3-4, this is for example only and is not intended to be limiting in any manner, as any other healthcare provider may be substituted therein for the pharmacy/pharmacist. Each healthcare provider computer 104 may be any suitable processor-driven device that facilitates the processing of healthcare requests made by clients 120 (e.g., patients or consumers) and the communication of information associated with healthcare transactions, such as healthcare claim transactions, to the primary payor computer 108, such as a server computer, a mainframe computer, one or more networked computers, a desktop computer, a personal computer, a digital assistant, a personal digital assistant, a digital tablet, an Internet appliance, an application-specific circuit, microcontroller, minicomputer, or any other processor-based device. In certain example embodiments, each healthcare provider computer 104 may be a suitable point of sale device associated with a healthcare provider. The execution of the computer-implemented instructions by the healthcare provider computer 104 may form a special purpose computer or other particular machine that is operable to facilitate the processing of healthcare requests made by patients and the communication of information associated with healthcare transactions to a primary payor computer 108 and/or administrator computer 106. Additionally, in certain exemplary embodiments, the operations and/or control of each healthcare provider computer 104 may be distributed amongst several processing components.

In addition to having one or more processors 124, each healthcare provider computer 104 may include one or more memory devices 126, one or more input/output (“I/O”) interfaces 128, and one or more network interfaces 130. The memory devices 126 may be any suitable memory device, for example, caches, read only memory devices, random access memory devices, magnetic storage devices, removable storage devices, etc. The memory devices 126 may store data, executable instructions, and/or various program modules utilized by the healthcare provider computer 104, for example, data files 132, an operating system (“OS”) 134, and/or a client module 138, respectively. The data files 132 may include any suitable data that facilitates the receipt and/or processing of healthcare requests by the healthcare provider computer 104 and the generation and/or processing of healthcare transactions that are communicated to the primary payor computer 108 and/or the administrator computer 106. For example, the data files 132 may include, but are not limited to, healthcare information and/or contact information associated with one or more clients, information associated with the particular healthcare provider and/or the respective healthcare provider computer 104, information associated with the administrator computer 106, information associated with one or more primary payors 108, and/or information associated with one or more healthcare transactions. The OS 134 may be any suitable software module that controls the general operation of the healthcare provider computer 104. The OS 134 may also facilitate the execution of other software modules by the one or more processors 124, for example, the client module 138. The OS 134 may be any currently existing or future developed operating system including, but not limited to, Microsoft Windows®, Apple OSX™, Linux, Unix, or a mainframe operating system.

The client module 138 may be an Internet browser or other suitable software, including a dedicated program, for interacting with the administrator computer 106 and/or the primary payor computer 108. For example, a pharmacist, pharmacy assistant, nurse practitioner, physician, nurse, or other pharmacy, hospital or physician's office employee may utilize the client module 138 in preparing and transmitting a healthcare transaction, such as an healthcare claim transaction, predetermination of benefits transaction, prescription claim or billing request, healthcare order transaction, or e-prescription transaction (i.e., electronic prescription order transaction, e-script, or e-prescription), to the service provider computer 106 for delivery to the appropriate primary payor computer 108 and/or administrator computer 106 or other third-party for adjudication or other coverage/benefits determination. The healthcare provider computer 104 may also utilize the client module 138 to retrieve or otherwise receive data, messages, or responses from the administrator computer 106, primary payor computer 108, and/or other components of the system 100. For example, in certain embodiments, the client module 138 may be utilized to receive a rejection of the healthcare transaction (e.g., no coverage information identified for the patient or for the particular medication or service being requested) for a patient from the primary payor computer 108 in response to transmitting the healthcare transaction as will be described below.

The one or more I/O interfaces 128 may facilitate communication between the healthcare provider computer 104 and one or more input/output devices, for example, one or more user interface devices, such as, a display, keypad, control panel, touch screen display, remote control, microphone, etc. that facilitate user interaction with the healthcare provider computer 104. For example, the one or more I/O interfaces 128 may facilitate entry of information associated with a healthcare transaction by an employee 120 of a healthcare provider, such as a pharmacy employee, pharmacist, physician, nurse, hospital employee, or nurse practitioner affiliated with a pharmacy, hospital, physician's office or other similar healthcare provider. The one or more network interfaces 130 may facilitate connection of the healthcare provider computer 104 to one or more suitable networks, for example, the network 110 illustrated in FIG. 1. In this regard, the healthcare provider computer 104 may receive and/or communicate information to other network components of the system 100, such as the administrator computer 106 and/or the primary payor computer 108.

With continued reference to FIG. 1, the administrator computer 106 may include, but is not limited to, any suitable processor-driven device that is configured for receiving, processing, and fulfilling requests from the one or more healthcare provider computers 104, the sponsor computer 115, the CRM database 182, and/or the primary payor computer 108 relating to pharmacy, benefits, billing, electronic prescription submission, and/or other healthcare transactions and/or other activities. In certain exemplary embodiments, the administrator computer 106 may be a secondary benefits adjudicator for healthcare transactions and/or other healthcare requests. For example, the administrator computer 106 may receive healthcare transactions from the healthcare provider computer 104 and/or the primary payor computer 108 and evaluate the transactions to determine secondary benefits, if any, provided in relation to the transaction. In certain additional embodiments, the administrator computer 106 may further act as a switch or service provider, routing healthcare transactions between the healthcare provider 104 and the primary payor computer 108 for adjudication by the primary payor.

In certain example embodiments, the administrator computer 106 may include a suitable host server, host module, or other software that facilitates the receipt of a healthcare transaction from a healthcare provider computer 104 and/or the primary payor computer 108 and the routing of the received healthcare transaction to the healthcare provider computer 104 and/or primary payor computer 108. Any number of healthcare provider computers 104, CRM databases 182, sponsor computers 115, and/or primary payor computers 108 may be in communication with the administrator computer 106, via the network 110 for example, as desired in various embodiments.

The administrator computer 106 may include any number of special purpose computers or other particular machines, application-specific circuits, microcontrollers, personal computers, minicomputers, mainframe computers, servers, networked computers, and/or other processor-driven devices. In certain embodiments, the operations of the service provider computer 106 may be controlled by computer-executed or computer-implemented instructions that are executed by one or more processors associated with the administrator computer 106 to form a special purpose computer or other particular machine that is operable to facilitate the receipt, routing, and/or processing of healthcare transactions. The one or more processors that control the operations of the administrator computer 106 may be incorporated into the administrator computer 106 and/or in communication with the administrator computer 106 via one or more suitable networks. In certain exemplary embodiments, the operations and/or control of the administrator computer 106 may be distributed amongst several processing components.

Similar to the healthcare provider computer 104 described above, the administrator computer 106 may include one or more processors 140, one or more memory devices 142, one or more I/O interfaces 144, and one or more network interfaces 146. The one or more memory devices 142 may be any suitable memory devices, for example, caches, read only memory devices, random access memory devices, magnetic storage devices, removable memory devices, etc. The one or more memory devices 142 may store data, executable instructions, and/or various program modules utilized by the administrator computer 106, for example, data files 148, an OS 150, the host module 154, a transaction processing subsystem 156, a CRM processing element 153, and a database management system (“DBMS”) 152 to facilitate management of data files 148 and other data stored in the memory devices 142. The OS 150 may be any currently offered or future developed operating system including, but not limited to, Microsoft Windows®, Apple OSX™, Linux, Unix, or a mainframe operating system. The OS 150 may be a suitable software module that controls the general operation of the administrator computer 106 and/or that facilitates the execution of other software modules.

The transaction processing subsystem 156 assists in evaluating healthcare transactions and processing benefits to clients 120 enrolled in one or more programs offered by the administrator. In this regard, the transaction processing subsystem 156 may include a software package based on a claims processing system. The transaction processing subsystem 156 is capable of capturing and/or adjudicating healthcare transactions for potential benefits, interventions or other services provided under one or more programs offered by the administrator based on one or more business rules and/or attributes applicable to the respective programs. One or more of the programs offered by the administrator may have an associated sponsor 115, such as the manufacturer or marketer of a medication or service to which the programs are directed. As such, the transaction processing subsystem 156 may utilize relational database technology and advanced logic to assign multiple identification numbers to a client 120 enrolled to participate in multiple programs offered by the administrator 106. Thus, to receive services (and, if so desired, benefits) under multiple programs of the administrator 106, as explained below, the client user may be issued a loyalty membership card tied to multiple programs from different sponsors and/or tied to a single sponsor 115 having multiple programs. The loyalty card, then, may include among other pieces of information, an identifier (client identification (ID) number) and/or source code associated with the respective client 120, a Bank Identification Number (BIN Number) and/or Processor Control Number (PCN), a program group number, and/or one or more identifiers (program identification numbers) associated with programs of the administrator 106 to which the respective client 120 is enrolled.

According to one exemplary embodiment, the data files 148 may store healthcare transaction records and benefit application business rules associated with communications received from various healthcare provider computers 104, various sponsor computers 115, and/or various primary payor computers 108. The data files 148 may also store any number of suitable routing tables that facilitate determining the destination of communications received from the healthcare provider computer 104, the sponsor computer 115, and/or the primary payor computer 108.

The host module 154 may receive, process, and respond to requests from the client module 138 of the healthcare provider computer 104, may further receive, process, and respond to requests of the host module 192 of the sponsor computer 115, and may further receive, process, and respond to requests of the host module 172 of the primary payor computer 108. The CRM processing element 153 may provide the capabilities for enrolling clients 120 in one or more programs associated with the administrator computer 106, as well as providing one or more services to clients 120 enrolled in programs associated with the administrator computer 106. The CRM processing element 153 may maintain a CRM database 182 for storing information associated with the programs and the clients 120 enrolled in those programs.

The CRM database 182 represents one or more databases that can be locally or remotely distributed with respect to the administrator computer 106. The client information maintained in the CRM database 182 may include, for example, demographic information such as the client's name, address, telephone number, e-mail address, and the like. The client information may also include the aforementioned client identification number and/or source code associated with the respective client 120, which may be included on a loyalty card issued to the client. In addition, the client information may include a listing of one or more programs of the administrator 106 to which the client is enrolled (or program identification numbers of such programs), one or more medications and/or services to which the client's enrolled programs are applicable, any particular services and/or benefits associated with respective applicable medications/services, historical purchases of applicable medications and/or services, the timing and/or frequency of those historical purchases, any scheduled forthcoming purchases of applicable medications and/or services, or the like.

The administrator computer 106 may also include additional program modules for performing other processing methods described herein. Those of ordinary skill in the art will appreciate that the administrator computer 106 may include alternate and/or additional components, hardware or software without departing from exemplary embodiments discussed herein.

With continued reference to the administrator computer 106, the one or more I/O interfaces 144 may facilitate communication between the administrator computer 106 and one or more input/output devices, for example, one or more user interface devices, such as a display, keypad, control panel, touch screen display, remote control, microphone, etc. that facilitate user interaction with the administrator computer 106. The one or more network interfaces 146 may facilitate connection of the administrator computer 106 to one or more suitable networks, for example, the network 110 illustrated in FIG. 1. In this regard, the administrator computer 106 may communicate with other components of the system 100.

With continued reference to FIG. 1, one or more sponsor computers 115 may be associated with the system 100. A sponsor computer 115 may be any suitable processor-driven device that is associated with a manufacturer or marketer of medications and/or services and provides support for and business and logic rules relating to secondary benefits to provide to clients related to the adjudication of healthcare transactions. In this regard, the sponsor computer 115 may provide business and logic rules to the administrator computer 106 and/or CRM database 182 for one or more primary and/or secondary benefit programs associated with respective ones of medications and/or services manufactured or marketed by the sponsor associated with the sponsor computer 115.

For example, the sponsor computer 115 may be a processor-driven device associated with a manufacturer or marketer of one or more medications and/or services available via submission of healthcare transactions. As desired, the sponsor computer 115 may include any number of special-purpose computers or other particular machines, application-specific circuits, microcontrollers, personal computers, minicomputers, mainframe computers, servers, and the like. In certain embodiments, the operations of the sponsor computer 115 may be controlled by computer-executed or computer-implemented instructions that are executed by one or more processors associated with the sponsor computer 115 to form a special-purpose computer or other particular machine that is operable to manage and provide business rules and/or logic associated with one or more benefit programs to one or more administrator computers 106 or another computer. The one or more processors that control the operations of the sponsor computer 115 may be incorporated into the sponsor computer 115 and/or in communication with the sponsor computer 115 via one or more suitable networks. In certain exemplary embodiments, the operations and/or control of the sponsor computer 115 may be distributed among several processing components.

Similar to other components of the system 100, the sponsor computer 115 may include one or more processors 181, one or more memory devices 183, one or more I/O interfaces 184, and/or one or more network interfaces 186. The one or more memory devices 183 may be any suitable memory device, for example, caches, read-only memory devices, random access memory devices, magnetic storage devices, removable memory devices, etc. The one or more memory devices 183 may store data, executable instructions, and/or various program modules utilized by the sponsor computer 115, for example, data files 190, an OS 188, a DBMS 191, and a host module 192. The data files 190 may include any suitable information that is utilized by the sponsor computer 115 to provider business rules and logic for one or more benefit programs associated with one or more medications and/or services. It will be appreciated that the same or similar information as provided by the data files 190 could likewise be stored in a data storage device communicably coupled to the sponsor computer 115.

Still referring to the sponsor computer 115, the OS 188 may be a suitable software module that controls the general operation of the sponsor computer 115. The OS 188 may also facilitate the execution of other software modules by the one or more processors 181, for example, the DBMS 191 and/or the host module 192. The OS 188 may be any currently existing or future developed operating system including, but not limited to, Microsoft Windows®, Apple OSX™, Linux, Unix, or a mainframe operating system. The DBMS 191 may be a suitable software module that facilitates access and management of one or more databases that are utilized to store information that is utilized by the sponsor computer 115 in various embodiments. The host module 192 may initiate, receive, process, and/or respond to requests, such as business rules and logic requests, from the host module 154 of the administrator computer 106. The sponsor computer 115 may include additional program modules for performing other methods as desired by an architect of the system 100. Those of ordinary skill in the art will appreciate that the sponsor computer 115 may include alternate and/or additional components, hardware, or software without departing from example embodiments of the disclosure.

With continued reference to FIG. 1, the primary payor computer 108 may be any suitable processor-driven device that facilitates receiving, processing, and/or fulfilling healthcare transactions, such as predetermination of benefits transactions, healthcare claim transactions, prescription claim or billing requests, healthcare order transactions, or e-prescription transactions (i.e., electronic prescription order transactions, e-scripts, or e-prescriptions) received directly or indirectly from the healthcare provider computer 104. For example, the primary payor computer 108 may be a processor-driven device associated with a pharmacy benefits manager (PBM), an insurer, a Medicare or other government payor, or a claims clearinghouse. As desired, the primary payor computer 108 may include any number of special purpose computers or other particular machines, application-specific circuits, microcontrollers, personal computers, minicomputers, mainframe computers, servers, and the like.

In certain exemplary embodiments, the operations of the primary payor computer 108 may be controlled by computer-executed or computer-implemented instructions that are executed by one or more processors associated with the primary payor computer 108 to form a special purpose computer or other particular machine that is operable to facilitate the receipt, processing, and/or fulfillment of healthcare transactions received directly or indirectly from the healthcare provider computer 104. The one or more processors that control the operations of the primary payor computer 108 may be incorporated into the primary payor computer 108 and/or in communication with the primary payor computer 108 via one or more suitable networks. In certain embodiments, the operations and/or control of the primary payor computer 108 may be distributed amongst several processing components.

Similar to other components of the system 100, the primary payor computer 108 may include one or more processors 158, one or more memory devices 160, one or more I/O interfaces 162, and one or more network interfaces 164. The one or more memory devices 160 may be any suitable memory devices, for example, caches, read only memory devices, random access memory devices, magnetic storage devices, removable memory devices. The one or more memory devices 160 may store data, executable instructions, and/or various program modules utilized by the primary payor computer 108, for example, data files 166, an OS 168, a DBMS 170, and a host module 172. The data files 166 may include any suitable information that is utilized by the primary payor computer 108 to process healthcare transactions, for example, patient profiles, patient insurance information, other information associated with a patient, information associated with a healthcare provider, etc. The OS 168 may be a suitable software module that controls the general operation of the primary payor computer 108. The OS 168 may also facilitate the execution of other software modules by the one or more processors 158, for example, the DBMS 170 and/or the host module 172. The OS 168 may be any currently existing or future developed operating system including, but not limited to, Microsoft Windows®, Apple OSX™, Linux, Unix, or a mainframe operating system.

The DBMS 170 may be a suitable software module that facilitates access and management of one or more databases that are utilized to store information that is utilized by the primary payor computer 108 in various embodiments. The host module 172 may initiate, receive, process, and/or respond to requests, such as healthcare transactions or claim requests, from the client module 138 of the healthcare provider computer 104. The primary payor computer 108 may include additional program modules for performing other pre-processing or post-processing methods described herein. Those of ordinary skill in the art will appreciate that the primary payor computer 108 may include alternate and/or additional components, hardware or software without departing from the example embodiments described herein.

The one or more I/O interfaces 162 may facilitate communication between the primary payor computer 108 and one or more input/output devices, for example, one or more user interface devices, such as a display, keypad, control panel, touch screen display, remote control, microphone, etc. that facilitate user interaction with the primary payor computer 108. The one or more network interfaces 164 may facilitate connection of the primary payor computer 108 to one or more suitable networks, for example, the network 110. In this regard, the primary payor computer 108 may receive healthcare transactions and/or other communications directly or indirectly from the healthcare provider computer 104 and the primary payor computer 108 may communicate information associated with processing the healthcare transactions to the healthcare provider computer 104 and/or the administrator computer 106.

The network 110 may include any telecommunication and/or data network, whether public, private, or a combination thereof, including a local area network, a wide area network, an intranet, the Internet, intermediate hand-held data transfer devices, and/or any combination thereof and may be wired and/or wireless. The network 110 may also allow for real-time, off-line, and/or batch transactions to be transmitted between or among the healthcare provider computer 104, the administrator computer 106, the sponsor computer 115, the CRM database 182, and/or the primary payor computer 108. Due to network connectivity, various methodologies, as described herein may be practiced in the context of distributed computing environments. Although the administrator computer 106 is shown for simplicity as being in communication with the healthcare provider computer 104, sponsor computer 115, the CRM database 182, and/or the primary payor computer 108 via one intervening network 110, it is to be understood that any other network configuration is possible. For example, intervening network 110 may include a plurality of networks, each with devices such as gateways and routers for providing connectivity between or among networks 110. Instead of or in addition to a network 110, dedicated communication links may be used to connect the various devices in accordance with an example embodiment. For example, the administrator computer 106 may form the basis of network 110 that interconnects one or more of the healthcare provider computer 104, sponsor computer 115, the CRM database 182, and the primary payor computer 108.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. For example, in one exemplary embodiment, the administrator computer 106 (or other computer) may be implemented as a specialized processing machine that includes hardware and/or software for performing the methods described herein. Accordingly, the exemplary embodiments described herein should not be construed as being limited to any particular operating environment, system architecture, or device configuration.

Operational Overview

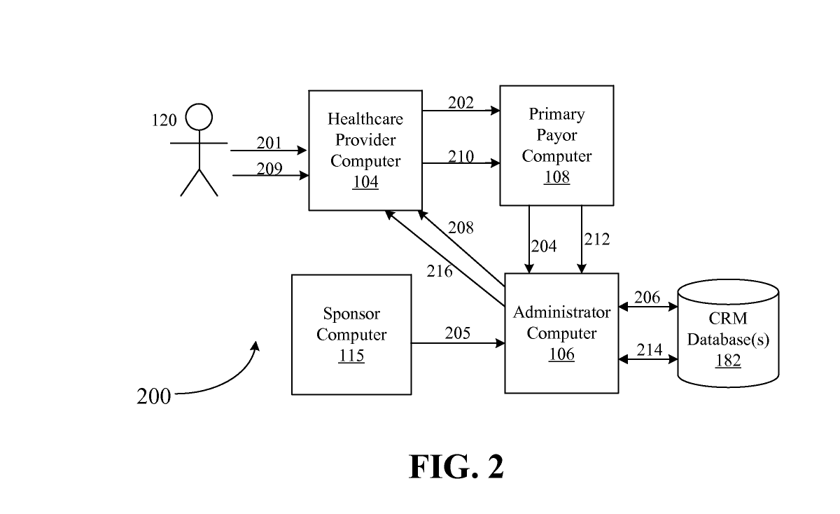

FIG. 2 is a diagram of one example data flow 200 for a real-time or near real time way to adjust secondary benefit levels for healthcare transactions for which primary benefits have been previously rejected for prior authorization by a primary payor and completed as part of the processing of a healthcare transaction. With reference to FIGS. 1 and 2, a healthcare provider computer 104 may receive a healthcare request 201 from a client 120, such as a request for a prescription medication. The healthcare request 201 may be received in-person or electronically as desired in various exemplary embodiments. For example, a client 120 may submit the request in-person at a pharmacy or physician's office or may alternately submit the request via a web portal or interactive voice response (IVR) system communicably coupled to the healthcare provider and/or the healthcare provider computer 104.

The healthcare provider computer 104 may receive and process the healthcare request 201 to generate a healthcare transaction 202. In one exemplary embodiment, the healthcare transaction is a healthcare claim transaction. However, it is understood that the examples are not limited to a healthcare claim transaction, but may include any other type of healthcare transaction including, but not limited to, a predetermination of benefits transaction, prescription claim or billing request, healthcare order transaction, or e-prescription transaction (i.e., electronic prescription order transaction, e-script, or e-prescription). The healthcare claim transaction 202 may be communicated by the healthcare provider computer 104 either directly or indirectly to the primary payor computer 108 for adjudication. According to one example embodiment, the healthcare claim transaction 202 may be formatted in accordance with a version of the National Council for Prescription Drug Programs (NCPDP) Telecommunication Standard, although other standards may be utilized as well. As desired, the healthcare claim transaction 202 may include any or all of, and is not limited to the following: patient first name; patient city, patient state, patient address, patient date of birth; zip/postal code; and Cardholder ID. In addition, the healthcare claim transaction 202 may also include additional information relating to the client, primary payor, prescriber, healthcare provider, secondary payor (administrator computer 106) and/or the requested medication/service. As an example, healthcare transactions submitted by the healthcare service provider computer 104 may include one or more of the following information:

Primary Payor ID/Routing Information
BIN Number (i.e. Banking Identification Number) and/or Processor Control Number (PCN) that designates a destination of the healthcare transaction for primary adjudication

### Patient Information

Name (e.g. Patient Last Name, Patient First Name, etc.)
Date of Birth of Patient
Age of Patient
Gender
Patient Address (e.g. Street Address, State, City, Zip Code, etc.)
Patient Contact Information (e.g. patient telephone number, email address, etc.)
Patient Health Condition Information
Patient ID or other identifier

Insurance/Coverage Information
Cardholder Name (e.g. Cardholder First Name, Cardholder Last Name)
Cardholder ID and/or other identifier (e.g. person code)
Group ID and/or Group Information

Prescriber Information
Primary Care Provider ID or other identifier (e.g. NPI code)
Primary Care Provider Name (e.g. Last Name, First Name)
Prescriber ID or other identifier (e.g. NPI code, DEA number)
Prescriber Name (e.g. Last Name, First Name)
Prescriber Contact Information (e.g. Telephone Number)
Pharmacy or other Healthcare Provider Information (e.g. store name, chain identifier, etc.)
Pharmacy or other Healthcare Provider ID (e.g. NPI code)

Claim Information
Medication, service, or product information (e.g. via National Drug Code (NDC) number)
Prescription/Service Reference Number
Date Prescription Written
Quantity Dispensed
Days' Supply
Diagnosis/Condition
Pricing information for the medication/service/product (e.g. network price, Usual & Customary price)
Number of Refills Authorized
One or more NCPDP Message Fields
One or more Drug Utilization (DUR) Codes
Date of Service.

Loyalty Membership Information
Client ID number
BIN and or PCN Number
Source code
Program Group Number
Sponsor

With continued reference to FIG. 2, the primary payor computer 108 may receive and adjudicate the healthcare claim transaction 202 or otherwise process the healthcare claim transaction 202. For example, the primary payor computer 108 may determine if benefits are available to the patient requesting the prescribed medication/service and the level of benefits to be provided for the particular healthcare claim transaction 202 according to an adjudication process associated with eligibility, pricing, and/or utilization review. The primary payor computer 108 may transmit an adjudicated healthcare claim transaction response 204 either directly or indirectly to the administrator computer 106 to determine if secondary benefits are available based on the requested medication/service, the loyalty card information, and/or the business rules 205 provided by the sponsor computer 115 to the administrator computer 106.

The administrator computer 106 may receive the adjudicated healthcare claim transaction response 204 from the primary payor computer 108. The administrator computer 106 may determine that the adjudicated healthcare claim transaction response 204 was rejected for failing to receive prior authorization from the primary payor. The administrator computer 106 can determine that a second secondary benefits program different from a first secondary benefits program is provided and associated with the requested medication/service or sponsor based on a determination that the transaction 204 is rejected for lack of prior authorization by a primary payor. The administrator computer 106 can store information 206 in the CRM database 182 associating or placing the particular client 120 in the second secondary benefits program for the requested medication/service and/or sponsor. A second secondary benefit associated with the second secondary benefits program can be provided by the administrator computer 106 in the adjudicated healthcare transaction response 208 and transmitted to the healthcare provider computer 104 to provider the medication/service to the client 120. As discussed below in FIG. 3, the exemplary second secondary benefits program provides a second secondary benefit that is different from and typically greater than the first secondary benefit provided under the first secondary benefits program for the same requested medication/service and/or sponsor.

In a subsequent transaction, the healthcare provider computer 104 may receive a healthcare request 209 from the client 120, such as a refill request for the same medication/service as the request 201. The healthcare provider computer 104 may process the healthcare request 209 to generate a healthcare transaction 210, such as a healthcare claim transaction 210. The healthcare claim transaction 210 may be communicated by the healthcare provider computer 104 either directly or indirectly to the primary payor computer 108 for adjudication.

The primary payor computer 108 may receive and adjudicate the healthcare claim transaction 210 or otherwise process the healthcare claim transaction 210. The primary payor computer 108 may transmit an adjudicated healthcare claim transaction response 212 either directly or indirectly to the administrator computer 106 to determine if secondary benefits are available based on the requested medication/service, the loyalty card information, and/or the business rules 205 provided by the sponsor computer 115 to the administrator computer 106.

The administrator computer 106 may receive the adjudicated healthcare claim transaction response 212 from the primary payor computer 108. The administrator computer 106 may determine that the adjudicated healthcare claim transaction response 212 was accepted or authorized for payment of a primary benefit. The administrator computer 106 can evaluate information 214 in the CRM database 182 to determine that the client 120 was previously placed in the second secondary benefits program for the requested medication/service and/or sponsor based on prior authorization rejection by the primary payor computer 108 and that, based on the current approval by the primary payor computer 108, the prior authorization requirements for the primary payor have been satisfied.

The administrator computer 106 can move or change the association of the client, based on the loyalty card information, from the second secondary benefits program to the first secondary benefits program in the CRM database 182. The administrator computer 106 can further provider a first secondary benefit under the first secondary benefits program in the adjudicated healthcare claim transaction response 216 and can transmit that response 216 to the healthcare provider computer 104. The client 120 can then receive the requested medication/service based on the primary benefit and the first secondary benefit.

FIGS. 3A and 3B are a flow chart of an example method 300 for providing a premium secondary benefit for healthcare transactions for which primary benefits are currently rejected by a primary payor 108 for lack of prior authorization by the primary payor 108 and completed as part of the processing of a healthcare transaction, such as a healthcare claim transaction, prescription claim or billing request, healthcare order transaction, or e-prescription transaction (i.e., electronic prescription order transaction, e-script, or e-prescription), in accordance with one exemplary embodiment. The exemplary method 300, described below, may be performed by an administrator computer 106. Furthermore, the exemplary methods 300 and 400, described below, will be described with reference to a pharmacy as the healthcare provider; however, this is only for purposes of example as other healthcare providers could be substituted for, and should each be individually read as being a part of each of these methods. As such, where the discussion of the methods 300 and 400 below and the drawings state a pharmacy, any other healthcare provider could be substituted, such as a physician, hospital, physician's office, prescriber of the medication, clinic, or healthcare center.

In addition, the exemplary methods 300 and 400 will be described with reference to a healthcare claim transaction; however, this also is only for purposes of example as other healthcare transactions (which may include, for example, a prescription claim or billing request, healthcare order transaction, or e-prescription transaction (i.e., electronic prescription order transaction, e-script, or e-prescription)) could be substituted for the healthcare claim transaction and each form of healthcare transaction should each individually be read as being used in the methods described below.

Referring now to FIGS. 1 and 3, the exemplary method 300 begins at the START step and proceeds to step 302, where a client 120 (e.g., patient or purchaser of medications/services) enrolls in one or more programs of the administrator 106, one or more of which may include an association with a sponsor associated with a sponsor computer 115. The client 120 may directly or indirectly enroll with programs of the administrator computer 106 in any of a number of different manners. For example, the client 120 may enroll with one or more programs via a healthcare provider during the purchase of a medication/service to which a respective program is applicable. Additionally or alternatively, for example, the client 120 may enroll with one or more programs independent of a healthcare provider before the purchase of an applicable medication/service. In either instance, however, at the time or, before, or after enrolling in the programs, the client may be presented with a loyalty card including, among other pieces of information, an identifier (client identification (ID) number) and/or source code associated with the respective client 120, a BIN or PCN number, a program group number, and/or one or more identifiers (program identification numbers) associated with the respective programs. The loyalty card may then be used for real-time program eligibility verification and transaction processing. The loyalty card need not be associated with any debit or credit card processes, although it should be realized that the loyalty card may be integrated with one or more of these funded account programs, if so desired.

Irrespective of exactly how the client 120 is enrolled with one or more programs of the administrator computer 106, the client 120 may thereafter be eligible to receive one or more services and, in conjunction with such services (if so established in accordance with program business rules) a secondary benefit for medications/services to which the respective program is applicable. In certain exemplary embodiments, the client 120 may be required to opt-in to a program before receiving some of the services and/or benefits of a program. In such instances, the client 120 may activate their loyalty card to receive some services and/or benefits of a program, such as by receiving a service and/or benefit with a limited purchase or time enrollment with the program. The client 120 may then be required to separately opt-in to the program long term to continue to receive those services and/or programs, and/or to receive additional services and/or programs.

As indicated above, the services of the program may be received in addition to any applicable primary benefit provided, for example, by the primary payor computer 108 for such medications/services, if appropriate. In this regard, after enrolling the client 120, the method includes the client 120 purchasing an applicable medication/service from a healthcare provider, or in other words the healthcare provider computer 104 generating and transmitting a healthcare claim transaction for adjudication for the client 120. The respective purchase may be effectuated, for example, by presenting a qualifying medication/service (or identifier of such a medication/service) and a loyalty card (or client identification number and/or source code otherwise printed on such a card) for the program to a healthcare provider for inclusion in the healthcare claim transaction at the healthcare provider computer 104. While the exemplary embodiment of FIG. 3 describes enrollment into the programs of the administrator occurring prior to making a prescription request and the pharmacist dispensing the prescription, in alternative embodiments, enrollment by the client can occur after the medication has been dispensed or after a prescription request has been submitted and before the prescribed medication/service has been dispensed.

In step 304, a pharmacist at a pharmacy receives a prescription request from a client 120. The prescription is typically received by the client 120 from a prescriber of the medication, such as a doctor, dentist, nurse, or physician's assistant. The client 120 may go to the location of the pharmacy and physically hand the prescription request to the pharmacist or make a request via a web portal communicably coupled to the healthcare provider computer 104 or an IVR communicably coupled to the healthcare provider computer 104. In addition to providing the healthcare request (e.g., script or prescription information) the client 120 can provide insurance coverage information and a loyalty card or information from the loyalty card to the pharmacist in step 306. The pharmacist determines the client 120 and/or patient's name and accesses the healthcare provider computer 104, which receives a selection of client 120 and/or patient information from the pharmacist via the I/O interface 128 in step 308. For example, the pharmacist can access the healthcare provider computer 104 and access a database of client information, which may be stored in memory 126 or in another database either local or remote from the healthcare provider computer 104. The pharmacist can then select the name or other client identification information in the client information database that matches the name or other identification information provided by the client 120.

In step 310, a healthcare claim transaction is generated and/or formatted at the healthcare provider computer 104. In certain exemplary embodiments, the healthcare provider computer 104 formats the healthcare claim transaction with client information, insurance information, loyalty card information (e.g., the client ID number, BIN/PCN number for a sponsor or secondary benefits payor, and/or program group number) and prescription information. The information can be input into the healthcare claim transaction by the pharmacist via the I/O interface 128. In one exemplary embodiment, the client information includes one or more of the following: patient first name, patient last name, date of birth, gender code, patient street address, patient city address, patient zip/postal zone, patient contact information (e.g., phone number and/or email address), patient ID, and insurance or other coverage information for the patient. In certain example embodiments, the insurance/coverage information may include one or more of the following: cardholder name (e.g., first and last name of the patient/cardholder), cardholder ID, person code, group ID number, relationship code, or state or other governmental entity payor information. The prescription information in the predetermination of benefits transaction may include, but is not limited to, one or more of the following: prescriber name or ID (e.g., NPI code or DEA number), pharmacy information (e.g., store name, chain name, location, number or other identifier), pharmacy ID number (e.g., NPI code), prescribed drug information (e.g., NDC code), date of prescription, quantity dispensed, days' supply, refill number, number of refills authorized, pricing information, and primary payor ID (e.g., BIN or PCN number).

The healthcare provider computer 104 transmits the healthcare claim transaction, either directly or indirectly, to the primary payor computer 108 in step 312. In certain exemplary embodiments, the healthcare claim transaction is transmitted from the healthcare provider computer 104 to a service provider or switch (not shown) and from the service provider or switch to the primary payor computer 108. In this exemplary embodiment, the healthcare claim transaction can undergo certain forms of editing and evaluation at the switch (e.g., determining the proper primary payor to transmit the healthcare claim transaction to based on the BIN number) prior to forwarding the healthcare claim transaction to the primary payor computer 108.

The primary payor computer 108 receives and adjudicates the healthcare claim transaction in step 314 to determine if the claim for the requested medication/service is covered and to what extent the patient's coverage covers the requested medication/service identified in the transaction. Example adjudications can include, but are not limited to, accepted, approved, paid, captured, denied, and denied with request for additional information and resubmission. In certain exemplary embodiments, the adjudication can be input into a field of the healthcare claim transaction, in the form of a code that is recognized by the administrator computer 106 and/or the healthcare provider computer 104. For example, the healthcare claim transaction can include a code identifying that the transaction is being rejected by the primary payor at the primary payor computer 108 because prior authorization is required from the primary payor before the primary benefits will be paid by the primary payor for the requested medication/service. In step 316, the primary payor computer 108 transmits, either directly or indirectly, the adjudicated healthcare claim transaction response to the administrator computer 106 via, for example, the network 110. For example, the adjudicated healthcare transaction response can be transmitted from the primary payor computer to a service provider or switch (not shown) and subsequently from the switch to the administrator computer 106. In this exemplary embodiment, the adjudicated healthcare claim transaction response can undergo certain forms of editing and evaluation at the switch (e.g., determining the proper administrator to transmit the healthcare claim transaction to based on an identification of a secondary benefit program or the client ID number in the adjudicated healthcare claim transaction response) prior to forwarding the adjudicated healthcare claim transaction response to the administrator computer 106.

In step 318, an inquiry is conducted to determine if the healthcare claim transaction was approved. In one exemplary embodiment, the determination can be made by the transaction processing subsystem 156 based on an evaluation of one or more fields of the received adjudicated healthcare claim transaction response from the primary payor computer 108. If the healthcare claim transaction was approved, the YES branch is followed to step 320, where the transaction processing subsystem evaluates the received adjudicated healthcare claim transaction response to identify the medication/service being requested by the client 120 and the client ID number for the client's loyalty card. For example the transaction processing subsystem can determine the medication/service being requested based on the NDC number in the received adjudicated healthcare claim transaction response. Furthermore, as discussed above, the adjudicated healthcare claim transaction response can include a recognized field for containing the client ID number of the client's loyalty card. Based on the identification of the medication/service being requested and the client ID number, the administrator computer can determine if secondary benefit is available and can be provided to the client 120.

In certain exemplary embodiments, the secondary benefit may be provided to the client 120 in the form of a financial incentive covering a portion of an out-of-pocket expense for medications/services to which the client's enrolled programs are applicable (applicable medications and/or services). However, it should be understood that a secondary benefit need not be monetary. In those instances in which the benefit is a financial incentive, however, the otherwise out-of-pocket expense may be determined by the administrator computer 106 in any of a number of different ways, such as via a connection of the administrator to pharmacies using the coordination of benefits (COB) segment of a NCPDP ver. 5.1 formatted healthcare claim transaction submission, the COB segment including a secondary payer field. In certain exemplary embodiments, the secondary benefit may be tied to a patient's actual primary benefit, such as by determining the secondary benefit as a percentage of a primary benefit. For example, the secondary benefit may be tied to, and calculated as a percentage of, the co-pay of a primary payor prescription plan, thereby providing flexibility to address the needs of client 120 relative to their prescription coverage.

For example, according to one exemplary embodiment, a first secondary benefits program could be designed to capture the client's cost-share requirement for a medication/service as determined by the client's prescription drug coverage and subsequently provide the client an additional discount on the final prescription cost. This additional discount amount could be calculated instantly by the transaction processing subsystem 156 and provided to the healthcare provider computer 104 and thereafter the client 120 at the point of sale and dispensing. Although fixed discounts may be offered, such as a flat $5.00 discount, other techniques may be used, such as variable discounts which reduce all client cost-share amounts, regardless of individual drug benefit coverage, to a fixed dollar amount. Alternatively, percentage discounts may be useful in certain circumstances (e.g., reduce client calculated co-pay by 15%). In other instances, the sponsor may deploy, via the sponsor computer 115, a program that combines certain aspects of these options to create additional discount calculation options. In yet another exemplary embodiment, the benefit may be a “pay no more than benefit” provided under the first secondary benefits program. For example, the pay no more than benefit is typically a variable benefit based on the primary benefit that is also being provided to the client and is determined such that the combination of the primary and the secondary benefit being provided to the client is no more than a predetermined amount (e.g., pay no more than $100 in total benefit, reduce the final co-pay for the client to no less than $20), which can vary based on the particular desires of the sponsor for that particular program.

In step 322, the transaction processing subsystem 156 can provide a secondary benefit based on a first secondary benefit program based on the business rules provided by the sponsor, via for example the sponsor computer 115, and/or medication/service being requested by the client 115. For example, the transaction processing subsystem can modify the received adjudicated healthcare claim transaction response to include an indication of the secondary benefit in a field of the transaction recognized by the healthcare provider computer 104. The administrator computer 106 transmits, either directly or indirectly, the adjudicated healthcare claim transaction response to the healthcare provider computer 104 in step 324.

The healthcare provider computer 104 receives the approved adjudicated healthcare claim transaction response via the network 110 in step 326. In step 328, the healthcare provider computer determines the primary benefit and the secondary benefit to be provided to the client 120 and provides the requested medication/service to the client 120 based on the received primary and secondary benefit. For example, the client 120 can provide a reduced co-pay amount based on the primary and secondary benefit in exchange for receiving the requested medication/service. The process then continues to the END step.

Returning to the inquiry of step 318, if the healthcare claim transaction was not approved by the primary payor computer 108, the NO branch is followed to step 330, where the transaction processing subsystem 156 determines the basis for the rejection of the adjudicated healthcare claim transaction response by the primary payor computer 108. For example, the transaction processing subsystem 156 can parse the adjudicated healthcare claim transaction response and identify a rejection code in an agreed upon field of the transaction and can compare that code to a schedule, table or database of rejection codes to determine the reasoning for rejection the healthcare claim transaction.

In step 332, an inquiry is conducted to determine if the basis for the rejection is a need for prior authorization by the primary payor. As discussed above, the transaction processing subsystem 156 can determine if the rejection is a prior authorization rejection based on the rejection code inserted into the adjudicated healthcare claim transaction response by the primary payor computer 108. If the basis of the rejection is not for prior authorization, the NO branch is followed to step 334, where the administrator computer 106 transmits, either directly or indirectly, the adjudicated healthcare claim transaction response to the healthcare provider computer 104. The healthcare provider computer 104 receives the rejection in the adjudicated healthcare claim transaction response in step 336 and the pharmacist can provide the client 120 with notification of the rejection of primary benefits. The process then continues to the END step.

Returning to the inquiry of step 332, if the basis for the rejection is a need for prior authorization by the primary payor associated with the primary payor computer 108, the YES branch is followed to step 338, wherein the transaction processing subsystem 156 can determine the identity of the medication/service being requested in the transaction and the sponsor associated with the requested medication/service. In one exemplary embodiment, the transaction processing subsystem 156 can determine the medication/service based on the NDC number for the requested medication/service in the transaction. The transaction processing subsystem 156 may then determine the sponsor based on an association of the sponsor and the NDC number in, for example, the CRM database 182.

In step 340, an inquiry is conducted to determine if the medication/service or sponsor is a participant in the prior authorization remediation program. In one exemplary embodiment, the sponsors (e.g., manufacturers and/or marketers of the medications/services) who are participants in the prior authorization remediation program can be identified in a listing, schedule, or database, such as the CRM database 182. In certain exemplary embodiments, sponsors participating in the prior authorization remediation program can have the first secondary benefit program for providing a first secondary benefit when the primary payor also approves the healthcare claim transaction and a second secondary benefit program for providing a second secondary benefit different from the first secondary benefit when the primary payor rejects the healthcare claim transaction based on a need for prior authorization or another basis that may be requested by the sponsor. For example, when both the second secondary benefit and first secondary benefit are financial benefits, the second secondary benefit can be greater than the first secondary benefit. In certain exemplary embodiments, the second secondary benefit is such that the client receives the requested medication/service free of charge. In another exemplary embodiment, the second secondary benefit is equal to the amount of the primary benefit that the client 120 would have received if the primary payor had not rejected payment for the transaction. In another exemplary embodiment, the second secondary benefit is equal to the combined amount of the primary benefit and the first secondary benefit that the client 120 would have received if the primary payor had not rejected payment for the transaction. If the sponsor or the medication/service is not enrolled as participants in the prior authorization remediation program, the NO branch is followed back to step 334, where the rejection is sent to the healthcare provider computer 104. Otherwise, the YES branch is followed to step 342, where the client 120 is associated with or moved from the first secondary benefits program associated the medication/service and/or sponsor to a second secondary benefits program associated with the medication/service and/or sponsor. For example, the CRM database 182 or another storage device can include two separate benefit groups (e.g., the first secondary benefits program and the second secondary benefits program) for the particular medication/service and/or sponsor under the prior authorization remediation program. In one exemplary embodiment, the transaction processing subsystem 156 can associated the client 120 based on the loyalty card information (e.g., the client ID number or source code) with the second secondary benefits program. For example, the client ID number or source code for the loyalty card can be included in the list, schedule, or database for the second secondary benefits program. Alternatively, a record in the CRM database 182 associated with the loyalty card information for the client can optionally be provided with flagging or association capabilities to both the first and second secondary benefit programs and as such the client ID number or source code representing the loyalty card for the client can include a flag or other indication to associate the client with the second secondary benefit program for the particular medication/service and/or sponsor.

In step 344, the rejection of the adjudicated healthcare transaction response is removed or otherwise overridden by providing an indication in the adjudicated healthcare claim transaction response that a second secondary benefit will be provided to the client by the sponsor by way of the administrator computer 106. In one exemplary embodiment, the indication of provision of the second secondary benefit can be input into an agreed-upon field of the adjudicated healthcare claim transaction response by the transaction processing subsystem 156. The revised adjudicated healthcare claim transaction response can be transmitted to the healthcare provider computer 104 to provide the second secondary benefit for the requested medication/service to the patient. In one exemplary embodiment, the second secondary benefit covers the entire cost of the requested medication/service such that the client 120 is able to receive the requested medication/service without cost to the client 120 during the initial request even though the primary payor associated with the primary payor computer 108 rejected the healthcare claim transaction for lack of prior authorization. In another exemplary embodiment, the second secondary benefit is equal to the amount of the primary benefit that the client 120 would have received if the primary payor had not rejected payment for the transaction. In yet another exemplary embodiment, the second secondary benefit is equal to the combined amount of the primary benefit and the first secondary benefit that the client 120 would have received if the primary payor had not rejected payment for the transaction.

In step 346 the transaction processing subsystem 156 determines, based on loyalty card information, if the client 120 has opted into a program requesting contact from the administrator/sponsor based on receipt of a prior authorization rejection from the primary payor. In one exemplary embodiment, the subsystem 156 evaluates the record associated with the customer ID number for the loyalty card of the client 120 in the CRM database 182 to determine if the client 120 has opted into the contact program. If the client 120 has not opted into the program, the NO branch is followed to the END step. Otherwise, the YES branch is followed to step 350, where the transaction processing subsystem 156 can determine the contact information for the client. The contact information can include, but is not limited to, a phone number, email address, or mailing address. In certain exemplary embodiments, the subsystem 156 can determine the contact information for the client 120 by evaluating the record associated with the customer ID number for the loyalty card of the client 120 in the CRM database 182. As discussed above, each of the phone number, email address, and home address can be received as part of the enrollment process and stored in the record of the client in the CRM database 182 based on the client ID number, client name, and/or source code information from the loyalty card.

The client 120 is then contacted by the administrator, administrator computer 106, sponsor, and/or sponsor computer regarding the prior authorization rejection by the primary payor based on the contact information. For example, the administrator computer 106 can generate an email and transmit the email to the email address of the client 120. Alternatively, the client 120 can be called on the telephone and provided with information on how to receive prior authorization so that it does not create any issues for subsequent purchases of the requested medication/service. The process then continues to the END step.

FIG. 4 is a flow chart of an example method 400 for adjusting the secondary benefit level for a healthcare transaction related to a prior healthcare transaction for which primary benefits payment was rejected for lack of prior authorization by a primary payor and completed as part of the processing of the healthcare transaction, in accordance with one exemplary embodiment. Referring now to FIGS. 1 and 4, the exemplary method 400 begins at the START step and proceeds to step 402, where a pharmacist at a pharmacy receives a prescription request for a refill of a medication/service from a client 120. The client 120 can also provide insurance coverage information and a loyalty card or information from the loyalty card to the pharmacist in step 404. The pharmacist determines the client 120 and/or patient's name and accesses the healthcare provider computer 104, which receives a selection of client 120 and/or patient information from the pharmacist via the I/O interface 128 in step 406. For example, the pharmacist can access the healthcare provider computer 104 and access a database of client information, which may be stored in memory 126 or in another database either local or remote from the healthcare provider computer 104. The pharmacist can then select the name or other client identification information in the client information database that matches the name or other identification information provided by the client 120.

In step 408, a healthcare claim transaction is generated and/or formatted at the healthcare provider computer 104. In certain exemplary embodiments, the healthcare provider computer 104 formats the healthcare claim transaction with client information, insurance information, loyalty card information (e.g., the client ID number and/or source code) and prescription information similar to that described above in FIG. 3. The information can be input into the healthcare claim transaction by the pharmacist via the I/O interface 128.

The healthcare provider computer 104 transmits the healthcare claim transaction, either directly or indirectly, to the primary payor computer 108 in step 410. In certain exemplary embodiments, the healthcare claim transaction is transmitted from the healthcare provider computer 104 to a service provider or switch (not shown) and from the service provider or switch to the primary payor computer 108.

The primary payor computer 108 receives and adjudicates the healthcare claim transaction in step 412 to determine if the claim for the requested medication/service is covered and to what extent the patient's coverage covers the requested medication/service identified in the transaction. In certain exemplary embodiments, the adjudication can be input into a field of the healthcare claim transaction, in the form of a code that is recognized by the administrator computer 106 and/or the healthcare provider computer 104. In step 414, the primary payor computer 108 transmits, either directly or indirectly, the adjudicated healthcare claim transaction response to the administrator computer 106 via, for example, the network 110. For example, the adjudicated healthcare transaction response can be transmitted from the primary payor computer 108 to a service provider or switch (not shown) and subsequently from the switch to the administrator computer 106.

In step 416, an inquiry is conducted to determine if the healthcare claim transaction was approved. In one exemplary embodiment, the determination can be made by the transaction processing subsystem 156 based on an evaluation of one or more fields of the received adjudicated healthcare claim transaction response from the primary payor computer 108. If the healthcare claim transaction was not approved by the primary payor computer 108, the NO branch is followed to step 330 of FIG. 3A. If the healthcare claim transaction was approved, the YES branch is followed to step 418, where the transaction processing subsystem 156 evaluates the received adjudicated healthcare claim transaction response to identify the medication/service being requested by the client 120 and the client ID number for the client's loyalty card. For example the transaction processing subsystem 156 can determine the medication/service being requested based on the NDC number in the received adjudicated healthcare claim transaction response. Furthermore, as discussed above, the adjudicated healthcare claim transaction response can include a recognized field for containing the client ID number (and/or source code) of the client's loyalty card. Based on the identification of the medication/service being requested and the client ID number, the administrator computer can determine if the client 120 previously received a second secondary benefit under a second secondary benefit program for the requested medication/service. Receipt of the second secondary benefit by the client 120 for the requested medication/service would provide indication that the client 120 previously received a rejection from a primary payor based on a need for prior authorization before being prescribed the requested medication/service.

In step 420, an inquiry is conducted to determine if the primary benefits for a prior fill for this medication/service for the particular client 120 was rejected by the primary payor for lack of prior authorization. In one exemplary embodiment, the transaction processing subsystem 156 can make the determination by evaluating the group in the CRM database 182 associated with the second secondary benefit program to determine if the client ID number or source code is included in that benefit program. For examples where such second secondary benefit programs are provided for all medications/service provided by a sponsor, the record may also be evaluated to determine if it indicates the same medication/service as is currently being requested (such as by comparison of NDC numbers). Alternatively, the transaction processing subsystem 156 may look at the loyalty card record for the client in the CRM database 182 to determine if the record was flagged or otherwise associated with the second secondary benefit program, includes an NDC number that matches the NDC number of the currently requested medication/service and includes a counter variable that indicates the requested medication was previously received by the client 120 along with the second secondary benefit. If a payment of primary benefits was rejected for a prior fill of this medication/service for the client for lack of prior authorization from the primary payor, the YES branch is followed to step 422.

In step 422, a determination is made that the previous prior authorization requirement for the client and requested medication/service has been satisfied. In one exemplary embodiment, the determination is made base on the fact that a primary benefit payment for a prior fill of the medication/service was rejected for prior lack of authorization by the primary payor but the primary benefit payment for a current fill of the medication/service was not rejected by the primary payor computer 108 for need of prior authorization by the primary payor. Alternatively, a request for verification can be transmitted to the primary payor computer 108 and/or the prescriber to confirm that prior authorization requirements have been fulfilled. In step 424, the client is moved from the second secondary benefits program to the first secondary benefits program for the particular medication/service and/or sponsor. In one exemplary embodiment to change is effectuated by the transaction processing subsystem 156 of the administrator computer 106.

In one exemplary embodiment, the transaction processing subsystem 156 can move the association of the client 120 based on the loyalty card information (e.g., the client ID number or source code) from the second secondary benefits program to the first secondary benefits program. For example, the client ID number or source code for the loyalty card can be removed from the list, schedule, or database for the second secondary benefits program and included in the list, schedule, or database for the first secondary benefits program. Alternatively, in the record for the patient in the CRM database 182 based on the loyalty card information, the subsystem 156 can remove the flag or other indication associating the client 120 with the second secondary benefits program and can insert a flag or other indication to associate the client with the first secondary benefits program for the particular medication/service and/or sponsor.

Returning to the inquiry of step 420, if a primary benefits payment for a prior fill of the currently requested medication/service was not rejected for lack of prior authorization by the primary payor computer 108, the NO branch is followed to step 426. In step 426, a first secondary benefit is provided for the client 120 in the adjudicated healthcare claim transaction response. For example, the transaction processing subsystem 156 can insert and indication of the provision of the first secondary benefit by inputting a code or other information into an agreed-upon field of the adjudicated healthcare claim transaction response. The revised adjudicated healthcare claim transaction response can be transmitted directly or indirectly to the healthcare provider computer 104 to provide the first secondary benefit for the requested medication/service to the client 120 in step 428. In step 430, the healthcare provider computer 104 can receive the approved healthcare transaction response along with the indication of the primary and first secondary benefits. In step 430, the pharmacist can provide the client 120 with the requested medication/service based on the primary and first secondary benefit received. The process continues to the END step.

The methods described and shown in FIGS. 3A-4 may be carried out or performed in any suitable order as desired in various embodiments. Additionally, in certain exemplary embodiments, at least a portion of the operations may be carried out in parallel. Furthermore, in certain exemplary embodiments, less than or more than the operations described in FIGS. 3A-4 may be performed.

Accordingly, example embodiments disclosed herein can provide the technical effects of creating a system and method that provides a real-time or near real time way to adjust secondary benefit levels for healthcare transactions for which primary benefits were previously rejected for lack of prior authorization by a primary payor and completed as part of the processing of a healthcare transaction. In this regard, patients are able to receive requested medications/services without having to wait for a prior authorization to be completed and sponsors only have to provide enhanced secondary benefits for so long as the prior authorization has not been received from the primary payor.

Various block and/or flow diagrams of systems and methods and/or computer program products according to example embodiments are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, that includes a computer usable medium having a computer-readable program code or program instructions embodied therein, said computer-readable program code adapted to be executed to implement one or more functions specified in the flow diagram step or steps. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram step or steps.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of those set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer-implemented method, comprising:
receiving, at an administrator computer from a primary payor computer associated with a primary payor, a healthcare transaction for a patient, wherein the healthcare transaction comprises patient information, loyalty card information, a request for a provision of healthcare benefits, and a request for a refill of a prescribed medication or service;
determining, by the administrator computer, that the healthcare transaction is approved by the primary payor computer, wherein the healthcare transaction includes a designation of a primary benefit from the primary payor;
determining, by the administrator computer, that a prior authorization requirement for the primary payor has been satisfied based at least in part on the determination that the healthcare transaction is approved by the primary payor computer; and
changing, by the administrator computer, the provision of healthcare benefits for the client from an administrator associated with the administrator computer from a second secondary benefits program to a first secondary benefits program.

2. The computer-implemented method of claim 1, wherein the healthcare transaction is an adjudicated healthcare transaction response.

3. The computer-implemented method of claim 1, wherein the loyalty card information comprise at least one of a client identification number and a source code.

4. The computer-implemented method of claim 1, further comprising the steps of:
inserting, by the administrator computer, a designation of a first secondary benefit associated with the first secondary benefits program into the healthcare transaction; and
transmitting, by the administrator computer, the healthcare transaction from the administrator computer to a healthcare provider computer associated with a healthcare provider, wherein the prescribed medication or service, the primary benefit, and the first secondary benefit are configured to be provided to the client at the healthcare provider.

5. The computer-implemented method of claim 1, further comprising the steps of:
receiving, by the administrator computer from the primary payor computer, an initial healthcare transaction comprising the patient information, the loyalty card information; a request for an initial provision of healthcare benefits, and a request for an initial fill of the prescribed medication or service, wherein the initial healthcare transaction is received and adjudicated prior to the healthcare transaction;
determining, by the administrator computer, that the initial healthcare transaction is rejected by the primary payor computer;
determining, by the administrator computer, that the rejection of the initial healthcare transaction by the primary payor computer is a prior authorization rejection;
associating, by the administrator computer, the client with the second secondary benefits program based at least in part on the determination that the rejection by the primary payor computer is the prior authorization rejection;
inserting, by the administrator computer, a designation of a second secondary benefit associated with the second secondary benefits program into the initial healthcare transaction; and
transmitting the initial healthcare transaction from the administrator computer to a healthcare provider computer associated with a healthcare provider, wherein the prescribed medication or service and the second secondary benefit are configured to be provided to the client at the healthcare provider,
wherein the initial healthcare transaction is received by the administrator computer and transmitted from the administrator computer to the healthcare provider computer prior to the healthcare transaction being received by the administrator computer.

6. The computer-implemented method of claim 5, wherein determining that the initial healthcare transaction is rejected by the primary payor computer is based at least in part on an evaluation, by the administrator computer, of one or more codes in the initial healthcare transaction.

7. The computer-implemented method of claim 5, wherein the second secondary benefit covers an entire cost of the prescribed medication or service for the client and wherein the second secondary benefit provides a greater benefit to the client than a first secondary benefit.

8. The computer-implemented method of claim 5, further comprising the steps of:
determining, by the service provider computer, the loyalty card information in the healthcare transaction, wherein the loyalty card information comprises a client identification number; and
determining, by the service provider computer, based at least in part on the client identification number of the loyalty card information, if the initial healthcare transaction was rejected by the primary payor and if the rejection was the prior authorization rejection.

9. The computer-implemented method of claim 8, wherein determining based at least in part on the client identification number of the loyalty card information that the initial healthcare transaction was rejected by the primary payor and the rejection was the prior authorization rejection further comprises the steps of:
identifying, by the administrator computer, a client record based on the client identification number; and
determining, by the administrator computer, that the client identification number is included in a second secondary benefits program schedule comprising a plurality of clients included in the second secondary benefits program.

10. The computer-implemented method of claim 5, further comprising the steps of:
determining, by the administrator computer, based at least in part on the loyalty card information, that the client requested notification of the prior authorization rejection by the primary payor;
determining, by the administrator computer, based at least in part on the loyalty card information a contact information providing a point of contact for the client; and
transmitting, by the administrator computer, a notification to the client of the prior authorization rejection by the primary payor at the point of contact for the client.

11. A system, comprising;
at least one memory operable to store computer-executable instructions; and
at least one processor configured to access the at least one memory and execute the computer-executable instructions to:
receive from a primary payor computer associated with a primary payor a healthcare transaction for a patient, wherein the healthcare transaction comprises patient information, loyalty card information, a request for a provision of healthcare benefits, and a request for a refill of a prescribed medication or service;
determine that the healthcare transaction is approved by the primary payor computer, wherein the healthcare transaction includes a designation of a primary benefit from the primary payor;
determine that a prior authorization requirement for the primary payor has been satisfied based at least in part on the determination that the healthcare transaction is approved by the primary payor computer; and
change the provision of healthcare benefits for the client from an administrator associated with the administrator computer from a second secondary benefits program to a first secondary benefits program.

12. The system of claim 11, wherein the healthcare transaction is an adjudicated healthcare transaction response.

13. The system of claim 11, wherein the loyalty card information comprise at least one of a client identification number and a source code.

14. The system of claim 11, wherein the at least one processor if further configured to access the at least one memory and execute the computer-executable instructions to:
insert a designation of a first secondary benefit associated with the first secondary benefits program into the healthcare transaction; and
direct communication of the healthcare transaction from the administrator computer to a healthcare provider computer associated with a healthcare provider, wherein the prescribed medication or service, the primary benefit, and the first secondary benefit are configured to be provided to the client at the healthcare provider.

15. The system of claim 11, wherein the at least one processor if further configured to access the at least one memory and execute the computer-executable instructions to:
receive from the primary payor computer an initial healthcare transaction comprising the patient information, the loyalty card information; a request for an initial provision of healthcare benefits, and a request for an initial fill of the prescribed medication or service, wherein the initial healthcare transaction is received and adjudicated prior to the healthcare transaction;
determine that the initial healthcare transaction is rejected by the primary payor computer;
determine that the rejection of the initial healthcare transaction by the primary payor computer is a prior authorization rejection;
associate the client with the second secondary benefits program based at least in part on the determination that the rejection by the primary payor computer is the prior authorization rejection;
insert a designation of a second secondary benefit associated with the second secondary benefits program into the initial healthcare transaction; and
direct communication of the initial healthcare transaction from the administrator computer to a healthcare provider computer associated with a healthcare provider, wherein the prescribed medication or service and the second secondary benefit are configured to be provided to the client at the healthcare provider,
wherein the initial healthcare transaction is received by the administrator computer and communication of the initial healthcare transaction is directed from the administrator computer to the healthcare provider computer prior to the healthcare transaction being received by the administrator computer.

16. The system of claim 15, wherein the at least one processor is configured to determine that the initial healthcare transaction is rejected by the primary payor computer by accessing the at least one memory and executing the computer-executable instructions to evaluate one or more codes in the initial healthcare transaction.

17. The system of claim 15, wherein the second secondary benefit covers an entire cost of the prescribed medication or service for the client and wherein the second secondary benefit provides a greater benefit to the client than a first secondary benefit.

18. The system of claim 15, wherein the at least one processor is further configured to access the at least one memory and execute the computer-executable instructions to:
determine the loyalty card information in the healthcare transaction, wherein the loyalty card information comprises a client identification number; and
determine based at least in part on the client identification number of the loyalty card information, if the initial healthcare transaction was rejected by the primary payor and if the rejection was the prior authorization rejection.

19. The system of claim 18, wherein the at least one processor is configured to determine, based at least in part on the client identification number of the loyalty card information, that the initial healthcare transaction was rejected by the primary payor and the rejection was the prior authorization rejection by accessing the at least one memory and executing the computer-executable instructions to:
identify a client record based on the client identification number; and
determine that the client identification number is included in a second secondary benefits program schedule comprising a plurality of clients included in the second secondary benefits program.

20. The system of claim 15, wherein the at least one processor if further configured to access the at least one memory and execute the computer-executable instructions to:
determine, based at least in part on the loyalty card information, that the client requested notification of the prior authorization rejection by the primary payor;
determine, based at least in part on the loyalty card information, a contact information providing a point of contact for the client; and
direct communication of a notification to the client of the prior authorization rejection by the primary payor at the point of contact for the client.
